(19) United States
(12) Patent Application Publication
(10) Pub. No.: US 2020/0331108 A1
(43) Pub. Date: Oct. 22, 2020

(54) TOOL GRIPPER FOR MACHINE TOOL

(71) Applicant: HYUNDAI WIA CORPORATION, Changwon-si, Gyeongsangnam-do (KR)

(72) Inventors: Dal Ho LEE, Seoul (KR); Dennis KORFF, Bibensheim (DE); Erik NOWAK, Mannheim (DE); Johannes HOERNER, Darmstadt (DE)

(21) Appl. No.: 16/766,873

(22) PCT Filed: May 31, 2018
(86) PCT No.: PCT/KR2018/006219

§ 371 Date: May 26, 2020

(30) Foreign Application Priority Data
Nov. 30, 2017 (KR) 10-2017-0163013

(51) Int. Cl. B23Q 3/155

(52) U.S. Cl. CPC B23Q 3/1554; B23Q 2003/155404

(57) ABSTRACT

A tool gripper for a machine tool is proposed. The tool gripper includes: a base to which a tool magazine is detachably coupled; a pair of guide arms disposed at both sides of the base to make an insertion space for a tool with the base, each having a first end fixed to the base and a second end having a cantilever shape extending toward the tool, and each having a guide protrusion formed at the second end to come in contact with the tool such that the guide protrusions press both sides of the tool by elasticity acting at the second ends about fixed first ends; and a support extending toward the tool between the guide arms at both sides of the base and having a supporting protrusion supporting the tool at an end.

### TECHNICAL FIELD

The present invention relates to a tool gripper for mounting tools of a machine tool and, more particularly, to a tool gripper that is mounted on a machine tool which can automatically change tools, is configured in an integrated type to be able to minimize the number of parts, and makes it possible to elastically insert and take out tools.

### BACKGROUND ART

In general, machine tools are equipped with an automatic tool changer that enables automatic change of tools. An automatic tool changer is used when pulling out a tool, which has been used, from a spindle, and taking out a tool for the next machining from a tool magazine and then mounting the tool back in the spindle. A gripper is required to keep or move a tool mounted on the automatic tool changer.

Accordingly, grippers were implemented using a plurality of parts to perform the complicated mechanism of automatic tool changers in the related art. For example, when a spring is used to elastically grip a tool, there is a need for additional parts such as a bearing that supports the spring and enables a gripper to operate in addition to the spring, so the number of parts increases and the structure is complicated. Further, as the number of parts increases, additional problems are generated such as an increase of the assembly processes and cumbersome maintenance.

Accordingly, there is a need for a tool gripper for a machine tool, the tool gripper being able to simplify the production and assembly process thereof, simplify maintenance, and reduce the manufacturing cost by simplifying complicated components of grippers in the related art.

The description provided above as a related art of the present invention is just for helping understanding the background of the present invention and should not be construed as being included in the related art known by those skilled in the art.

There is KR10-2014-0047463(A) as related art.

### DISCLOSURE

### Technical Problem

The present invention has been made in an effort to solve the problems and an objective of the present invention is to provide a tool gripper for a machine tool, the tool gripper being able to simplify the production and assembly process thereof, simplify maintenance, and reduce the manufacturing cost by simplifying complicated components of grippers in the related art.

### Technical Solution

A tool gripper for a machine tool according to the present invention for achieving the objectives includes: a base to which a tool magazine is detachably coupled; a pair of guide arms disposed at both sides of the base to make an insertion space for a tool with the base, each having a first end fixed to the base and a second end having a cantilever shape extending toward the tool, and each having a guide protrusion formed at the second end to come in contact with the tool such that the guide protrusions press both sides of the tool by elasticity acting at the second ends about fixed first ends; and a support extending toward the tool between the guide arms at both sides of the base and having a supporting protrusion supporting the tool at an end.

The guide arms and the support may be disposed at a side of the base, and a fastening hole for fastening the tool magazine and a position hole in which a fixing pin enabling relative positioning to the tool magazine is fastened may be formed at another side of the base.

The pair of guide arms may be symmetrically formed and may support the tool with the same pressure by pressing the tool in opposite directions.

The guide protrusions may be spaced apart from second end portions of the guide arms toward the insertion space and manual grooves may be formed the second end portions and the guide protrusions, so the tool may be mounted and separated by removing pressing force of the guide arms through the manual grooves when the tool cannot be mounted and separated.

The guide protrusions may be spaced apart from second end portions of the guide arms toward the insertion space and second end portions of the guide arms may bend into the insertion space and then extend such that bending portions and the guide protrusions form manual grooves, so the tool may be mounted and separated by removing pressing force of the guide arms through the manual grooves when the tool cannot be mounted and separated.

The supporting protrusion may have a first end fixed to the support, a second end extending toward the tool, and a second end portion formed in a shape corresponding to an outer side of the tool and having a predetermined curvature.

A recessed groove recessed toward the support may be formed at a center of the first end of the supporting protrusion, so the supporting protrusion may be divided into a pair symmetric with the recessive groove therebetween, and the supporting protrusion may be formed in a cantilever shape, whereby when the tool is mounted, ends facing the guide arms may elastically press the tool in close contact with the tool.

The base, the guide arms, and the support may be made of the same material as a single part.

The guide protrusion may have a first guide portion facing an inlet through which the tool is inserted into the insertion space and a second guide portion facing the support.

The first guide portions may be formed in arc shapes being convex toward the insertion space and having a predetermined curvature, so when the tool is inserted, the tool may be guided in contact with the first guide portions.

The second guide portion may form a taper from an end of the first guide portion to the guide arm.

The guide protrusion may further have a connecting portion formed to be concave toward the guide protrusion between the second guide portion and the guide arm such that the entire length of the guide protrusion is small.

The first end of the guide arm may bend to make an obtuse angle with the base and then may bend and extend to make a right angle, whereby the guide protrusion may be given elasticity.

Both sides of the first end of the support may be recessed inward, so spacing grooves may be formed, and gaps between the guide protrusions and the support may be uniformly formed from the first ends of the guide arms to the guide protrusions by the spacing grooves.

The second end of the support may be larger in width than the first end, so a contact area between the tool and the support may increase.

A point where the guide protrusion comes in contact with the tool or the second end portion of the supporting protrusion may be given lower hardness than that of the other portion.

### Advantageous Effects

According to the tool gripper for a machine tool which has the structure described above, since the gripper is formed in an integrated type that minimizes the components, there is the advantage that manufacturing and assembling are simple and mass production is easy in comparison to the related art. Further, maintenance and replacement are easy, so productivity is improved. Further, when a worker manually inserts and pulls out a tool, the worker can work with only one hand, so convenience for the worker can be remarkably improved.

### DESCRIPTION OF DRAWINGS

FIG. 1 is a perspective view of a tool gripper for a machine tool according to an embodiment of the present invention.

FIG. 2 is a view of FIG. 1 seen from the bottom.

FIG. 3 is a plan view showing the case in which a tool has been mounted on the gripper.

FIG. 4 is a side view of FIG. 3.

### MODE FOR INVENTION

Hereafter, a gripper for a machine tool according to an embodiment of the present invention is described hereafter with reference to the accompanying drawings.

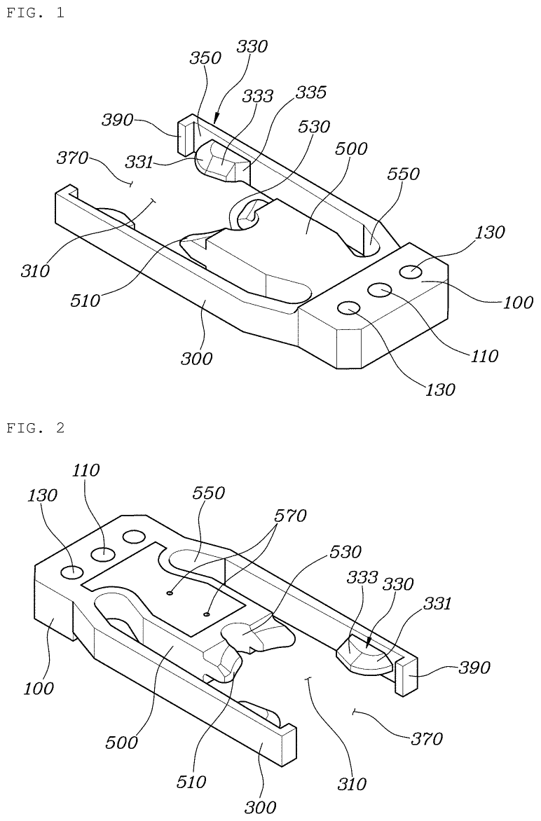

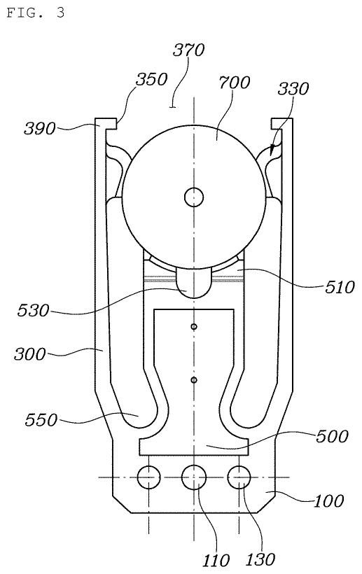

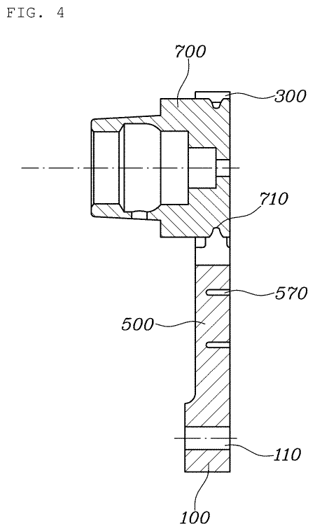

FIG. 1 is a perspective view of a tool gripper for a machine tool according to an embodiment of the present invention, FIG. 2 is a view of FIG. 1 seen from the bottom, FIG. 3 is a plan view showing the case in which a tool 700 has been mounted on the gripper, and FIG. 4 is a side view of FIG. 3.

As shown in FIGS. 1 and 2, a tool gripper for a machine tool according to an exemplary embodiment of the present invention includes: a base 100 to which a tool magazine (not shown) is detachably coupled; a pair of guide arms 300 disposed at both sides of the base 100 to make an insertion space 310 for a tool 700 with the base 100, each having a first end fixed to the base 100 and a second end having a cantilever shape extending toward the tool 700, and each having a guide protrusion 330 formed at the second end to come in contact with the tool 700 such that the guide protrusions 330 press both sides of the tool 700 by elasticity acting at the second ends about fixed first ends; and a support 500 extending toward the tool 700 between the guide arms 300 at both sides of the base 100 and having a supporting protrusion 510 supporting the tool 700 at an end. In particular, the base 100, the guide arms 300, and the support 500 may be made of the same material as a single part.

The base 100 is formed to have a predetermined thickness. The guide arms 300 and the support 500 are disposed at a side of the base 100 and a plurality of holes are formed at another side, in which the holes include a fastening hole 110 and positioning holes 130. Although it is exemplarily shown in FIG. 1 that a plurality of holes is formed in a line in the longitudinal direction of the base 100, the shape and the number of the holes that are formed at the base 100 may be freely changed, depending on the shape, the use, etc. of the tool magazine. The holes of the base 100 include a fastening hole 110 at the center and positioning holes 130 at both sides of the fastening hole 110. The fastening hole 110 is a threaded hole for fastening the gripper to the tool magazine through a fastening member (not shown) and the positioning holes 130 are holes in which fixing pins (not shown) are fastened to set the position of the gripper relative to the tool magazine. Accordingly, a position is set by inserting fixing pins into the positioning holes 130 formed at the base 100 and then the gripper is firmly fixed to the tool magazine by the fastening member and the fastening hole 110.

The base 100 is formed thicker than the guide arms 300 and the support 500, so a portion that needs to be ground when the gripper is formed and machined is easily distinguished and grinding is easily performed. That is, in the present invention, since the gripper and the tool magazine are combined through the base 100, the gripper and the tool magazine are in close surface contact with each other even only by the area of the base 100. Accordingly, there is the advantage that the surface contact portion is minimized and there is the advantage that it is possible to secure precision of the surface of the base 100 on which the gripper and the tool magazine are in close contact with each other.

The pair of guide arms 300 disposed at both sides of the base 100 and forming the insertion space 310 for the tool 700 with the base 100 is formed on a side of the base 100. The first ends of the guide arms 300 are fixed to the base 100 and the second arms have cantilever shapes extending toward the tool 700. The guide protrusions 330 that come in contact with the tool 700 are formed at the second ends of the guide arms 300, and respectively press both sides of the tool 700 by elasticity acting at the second end about the fixed first ends.

The pair of guide arms 300 is symmetrically formed. Accordingly, the guide arms 300 at both sides support the tool 700 with the same pressure by pressing the tool 700 in the opposite directions. In particular, it is possible to set elasticity at a desired level by changing the thickness or the length of the guide arms 300 in the present invention, and particularly, the guide arms 300 may be formed to be elastic such that the tool 700 can be mounted and separated by force of a person without a specific jig.

The guide protrusions 330 formed at the second ends of the guide arms 300 are spaced apart from the second end portions of the guide arm 300 toward the insertion space 310. The guide protrusions 330 are formed in an optimal shape for smoothly inserting and pulling the tool 700 and preventing separation of the tool 700 when the tool 700 are inserted and pulled. Accordingly, the guide protrusions 330, in more detail, each have a first guide portion 331 facing an inlet 370 through which the tool 700 is inserted into the insertion space 310, a second guide portion 333 facing the support 500, and a connecting portion 335 connecting the second guide 333 and the inside of the guide arm 300.

The first guide portions 331 are formed in arc shapes being convex toward the insertion space 310 and having a predetermined curvature, so when the tool 700 is inserted, the tool 700 is guided in contact with the first guide portions 331, whereby the tool 700 is easily inserted. The second guide portion 333 forms a taper from an end of the first guide portion 331 to the guide arm 300. That is, the second guide portions 333 are formed with a small inclination relative to the first guide portions 331 to have wide contact surfaces with the tool 700 so that the tool 700 is inserted in the insertion space 310, is moved on the tapers of the second guide portions 333, and is then positioned and stably mounted in the insertion space 310. The connecting portions 335 are formed to be concave toward the guide protrusions 330 between the second guide portions 333 and the guide arms 300 such that the entire lengths of the guide protrusions 330 are small. Accordingly, the thickness of the guide arms 300 is prevented from increasing due to extension of the guide protrusions 330 to the guide arms 300, and the surfaces on which the second guide portions 333 come in contact with the tool 700 are set. The gripper of the present invention is made of a material having hardness lower than that of the tool 700 and is formed as a single part, whereby wear of the contact surface of the tool 700 due to mounting and separating of the tool 700 is prevented, so there is an effect that durability of the tool 700 is increased. However, as described above, the gripper itself may be made of a material having lower hardness than that of the tool 700, but, depending on cases, the gripper itself may be made of a material having higher hardness than that of the tool 700 and the portions where the guide protrusions 330 come in contact with the tool 700 may be given lower hardness than that of other portion through post-machining or using another material, thereby being able to achieve the objective of preventing wear of the tool 700. This configuration is included in an embodiment of the present invention and can be freely changed in accordance with design, and the present invention is not limited only to this specific example.

A manual groove 350 is formed at the second end of the guide arm 300. The manual groove 350 is a groove formed so that a mounting/separating tool can be inserted in the gripper. The manual groove 350 enables a worker to separate the tool 700 from the gripper by removing the pressing force of the gripper by inserting a mounting/separating tool into the gripper through the manual groove 350 when the worker cannot pull out the tool 700 using force in some cases. The guide protrusion 330 is spaced toward the insertion space 310 from the second end portion of the guide arm 300 and the manual groove 350 is formed between the second end portion and the guide protrusion 330, so it is possible to mount/separate the tool 700 by removing the pressing force of the guide arm 300 through the manual groove 350 when it is impossible to mount/separate the tool 700. In particular, the guide protrusion 330 is spaced toward the insertion space 310 from the second end portion of the guide arm 300 and the second end portion of the guide arm 300 extends after bending toward the insertion space 310, whereby the manual groove 350 is formed between the bending portion 390 and the guide protrusion 330. Accordingly, when a worker cannot mount/separate the tool 700 using only force, it is possible to mount/separate the tool 700 by removing the pressing force of the guide arm 300 by inserting a mounting/separating tool into the gripper.

The base 100 has the support 500 extending toward the tool 700 between the guide arms 300 at both sides and having the supporting protrusion 510 supporting the tool 700 at the end. The support 500 is smaller in thickness than the base 100. The support protrusion 510 has a first end fixed to the support 500 and a second end extending toward the tool 700. The second end portion of the supporting protrusion 510 is formed in a shape corresponding to the outer side of the tool 700 and having a predetermined curvature. In particular, a recessed groove 530 recessed toward the support 500 is formed at the center of the first end of the supporting protrusion 510, so the supporting protrusion 510 is divided into a pair symmetric with the recessive groove 530 therebetween, and the supporting protrusion 510 is formed in a cantilever shape, whereby when the tool 700 is mounted, the ends facing the guide arms 300 elastically press the tool 700 in close contact with the tool 700. As described above, the reason that the supporting protrusion 510 is symmetrically disposed with the recessed groove 530 therebetween is for securing stability of the mounted tool 700 using two points. The number of the supporting protrusions 510 may be freely changed in accordance with design or necessity. The second end portion where the supporting protrusion 510 comes in contact with the tool 700 is given lower hardness than that of the other portion, whereby wear of the contact surface of the tool 700 due to mounting and separating of the tool 700 is prevented and accordingly durability of the tool 700 can be increased.

Further, identification holes 570 are formed in the bottom of the support 500. The identification holes 570 are provided to fix tags for identifying the tool 700 mounted on the gripper and the number and position of the identification holes 570 may be changed in accordance with the design or environment.

In the present invention, the first end of the guide arm 300 bends to make an obtuse angle with the base 100 and then bends and extends to make a right angle, whereby the guide protrusion 330 is given elasticity. In particular, both sides of the first end of the support 500 are recessed inward, so spacing grooves 550 are formed. The gaps between the guide protrusions 330 and the support 500 are uniformly formed from the first ends of the guide arms 300 to the guide protrusions 330 by the spacing grooves 550. The second end of the support 500 is larger in width than the first end, so the contact area between the tool 700 and the support 500 increases.

FIGS. 3 and 4 are views showing a case in which the tool 700 has been mounted on the gripper of the present invention, in which it can be seen that the tool 700 is stably mounted in the insertion space 310 by elasticity of the gripper with a V-groove 710 of the tool 700 fitted on the guide protrusions 330 and the supporting protrusion 510 of the gripper.

Therefore, according to the tool gripper for a machine tool of the present invention described above, since the gripper is formed in an integrated type that minimizes the components, there is the advantage that manufacturing and assembling are simple and mass production is easy in comparison to the related art. Further, maintenance and replacement are easy, so productivity is improved. Further, when a worker manually inserts and pulls out a tool, the worker can work with only one hand, so convenience for the worker can be remarkably improved.

Although the present invention was provided above in relation to specific embodiments shown in the drawings, it is apparent to those skilled in the art that the present invention may be changed and modified in various ways without departing from the scope of the present invention, which is described in the following claims.

### DESCRIPTION OF THE REFERENCE NUMERALS IN THE DRAWINGS

| | |
|---|---|
| 100: base | 110: fastening hole |
| 130: positioning hole | 300: guide arm |
| 310: insnertion space | 330: guide protrusion |
| 331: first guide portion | 333: second guide portion |
| 335: connecting portion | 350: manual groove |
| 370: inlet | 390: bending portion |
| 500: support | 510: supporting protrusion |
| 530: recession groove | 550: spacing groove |
| 570: identification hole | 700: tool |
| 710: V-groove | |

1. A tool gripper for a machine tool, comprising:
a base to which a tool magazine is detachably coupled;
a pair of guide arms disposed at both sides of the base to make an insertion space for a tool with the base, each having a first end fixed to the base and a second end having a cantilever shape extending toward the tool, and each having a guide protrusion formed at the second end to come in contact with the tool such that the guide protrusions press both sides of the tool by elasticity acting at the second ends about fixed first ends; and
a support extending toward the tool between the guide arms at both sides of the base and having a supporting protrusion supporting the tool at an end.

2. The tool gripper of claim 1, wherein the guide arms and the support are disposed at a side of the base, and a fastening hole for fastening the tool magazine and a position hole in which a fixing pin enabling relative positioning to the tool magazine is fastened are formed at another side of the base.

3. The tool gripper of claim 1, wherein the pair of guide arms is symmetrically formed and supports the tool with the same pressure by pressing the tool in opposite directions.

4. The tool gripper of claim 1, wherein the guide protrusions are spaced apart from second end portions of the guide arms toward the insertion space for the tool and manual grooves are formed between the second end portions and the guide protrusions, so the tool can be mounted and demounted by removing pressing force of the guide arms through using the grooves when the tool cannot be mounted or demounted.

5. The tool gripper of claim 1, wherein the guide protrusions are spaced apart from second end portions of the guide arms toward the insertion space for the tool and second end portions of the guide arms bend into the insertion space for the tool and then extend such that bending portions and the guide protrusions form grooves for manually loading and unloading the tool, so the tool can be mounted or demounted by removing pressing force of the guide arms through using the grooves when the tool cannot be mounted or demounted.

6. The tool gripper of claim 1, wherein the supporting protrusion has a first end fixed to the support, a second end extending toward the tool, and a second end portion formed in a shape corresponding to an outer side of the tool and having a predetermined curvature.

7. The tool gripper of claim 6, wherein a recessed groove recessed toward the support is formed at a center of the first end of the supporting protrusion, so the supporting protrusion is divided into a pair symmetric with the recessive groove therebetween, and the supporting protrusion is formed in a cantilever shape, whereby when the tool is mounted, ends facing the guide arms elastically press the tool in close contact with the tool.

8. The tool gripper of claim 1, wherein the base, the guide arms, and the support are made of the same material as a single part.

9. The tool gripper of claim 1, wherein the guide protrusion has a first guide portion facing an inlet through which the tool is inserted into the insertion space and a second guide portion facing the support.

10. The tool gripper of claim 9, wherein the first guide portions are formed in arc shapes being convex toward the insertion space and having a predetermined curvature, so when the tool is inserted, the tool is guided in contact with the first guide portions.

11. The tool gripper of claim 9, wherein the second guide portion forms a taper from an end of the first guide portion to the guide arm.

12. The tool gripper of claim 9, wherein the guide protrusion further has a connecting portion formed to be concave toward the guide protrusion between the second guide portion and the guide arm such that the entire length of the guide protrusion is small.

13. The tool gripper of claim 1, wherein the first end of the guide arm bends to make an obtuse angle with the base and then bends and extends toward the second end of the guide arm to make a right angle, whereby the guide protrusion is given elasticity.

14. The tool gripper of claim 13, wherein both sides of the first end of the support are recessed inward, so spacing grooves are formed, and gaps between the guide protrusions and the support are uniformly formed from the first ends of the guide arms to the guide protrusions by the spacing grooves.

15. The tool gripper of claim 14, wherein the second end of the support is larger in width than the first end, so a contact area between the tool and the support increases.

16. The tool gripper of claim 1, wherein a point where the guide protrusion comes in contact with the tool or the second end portion of the supporting protrusion is given lower hardness than that of the other portion.
